(19) United States
(12) Patent Application Publication
(10) Pub. No.: US 2016/0092482 A1
(43) Pub. Date: Mar. 31, 2016

(54) COMPILING DRILLING SCENARIO DATA FROM DISPARATE DATA SOURCES

(71) Applicant: LANDMARK GRAPHICS CORPORATION, Houston, TX (US)

(72) Inventors: Nadeem A. Haq, Richmond, TX (US); Gustavo Adolfo Urdaneta, Houston, TX (US)

(73) Assignee: LANDMARK GRAPHICS CORPORATION, Houston, TX (US)

(21) Appl. No.: 14/892,550

(22) PCT Filed: May 13, 2014
(86) PCT No.: PCT/US2014/037872

§ 371 Date: Nov. 19, 2015

Related U.S. Application Data
(60) Provisional application No. 61/828,486, filed on May 29, 2013.

(51) Int. Cl. G06F 17/30

(52) U.S. Cl. CPC G06F 17/30312; G06F 17/30867; G06F 17/30345

(57) ABSTRACT

An illustrative scenario compiling method that includes providing a visual representation of a well having well components mapped to different areas of the visual representation, responding to a selection of one of the well components with a list of data sets corresponding to the well component, retrieving a selected data set from a corresponding database, storing the data set in a common location with selected data sets of other well components, and saving the selected data sets as a scenario to be used for assembling a future collection of data sets as input for analysis software.

### CROSS-REFERENCE TO RELATED APPLICATION

This application claims priority to Provisional U.S. Application Ser. No. 61/828,486, titled “Methods and Systems for Creating an Instant Case from Disparate Data Sources” and filed May 29, 2013 by Nadeem A. Haq and Gustavo Adolfo Urdaneta, which is incorporated herein by reference.

### BACKGROUND

As the complexity of oil and gas well drilling operations have increased, oil and gas service providers have developed a variety of software and automated tools to analyze data acquired during drilling to improve drilling efficiency, avoid non-productive time, and maximize product recovery. These tools can access multiple databases with large amounts of acquired and simulated data in order to predict and evaluate drilling operations as they progress, allowing drilling operators to assess the drilling operation and make adjustments as needed. Such analysis may include, for example, forecasting future drilling scenarios, evaluating the drilling of a well as it progresses, or resolving unexpected problems (e.g., stuck pipe).

However, as the volume of data and number of databases has increased, so has the variety of data formats and programming languages used to access the various databases containing the data. Such variety may accordingly require various program calls in different programming languages to the databases. Additional filtering may be required to only work with a small subset of overall data and/or remove bad data. As a result, much if not all of the selection and filtering done to prepare the data for analysis is performed manually, a process that can take hours. This time represents non-productive time and increased costs for situations where drilling is suspended pending the results of the analysis.

### BRIEF DESCRIPTION OF THE DRAWINGS

Accordingly, there are disclosed herein scenario compiling methods and computer programs using disparate data sources. In the drawings:

FIG. 1 shows an illustrative drilling environment.

FIG. 2 shows one embodiment of an illustrative user interface display.

FIG. 3 shows an illustrative dialog box.

FIG. 4 depicts an illustrative computer program stored in a non-transitory computer readable medium within a computer system.

FIG. 5 depicts a flow diagram of an illustrative method for compiling a scenario.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Certain disclosed methods and computer programs provide a visual representation of a well and well components for compiling a drilling scenario. The visual representation includes selectable well components that, when selected, responsively provide a list of corresponding data sets. Upon selection of a data set by a user, the data set is retrieved from a corresponding database and stored in a common location with selected data sets from the other well components. The selected data sets may be saved as a scenario that can be recalled at a future point in time as input for the analysis software.

The visual representation may update in response to a selection of one of the data sets. Additionally, the stored data may be used to perform an analysis of the well or to refine well-related predictions, thereby enabling users to take actions based thereon. Prior to the analysis, data sets may be correlated using common fields to align the data sets from different databases, such as timestamps, in each data set. Moreover, as a well component may have data sets in various databases, such data sets may be compared or a consistency check performed to determine which is the correct or most up to date data. Based thereon, the old or incorrect data in one of the databases may be replaced with the new or correct data.

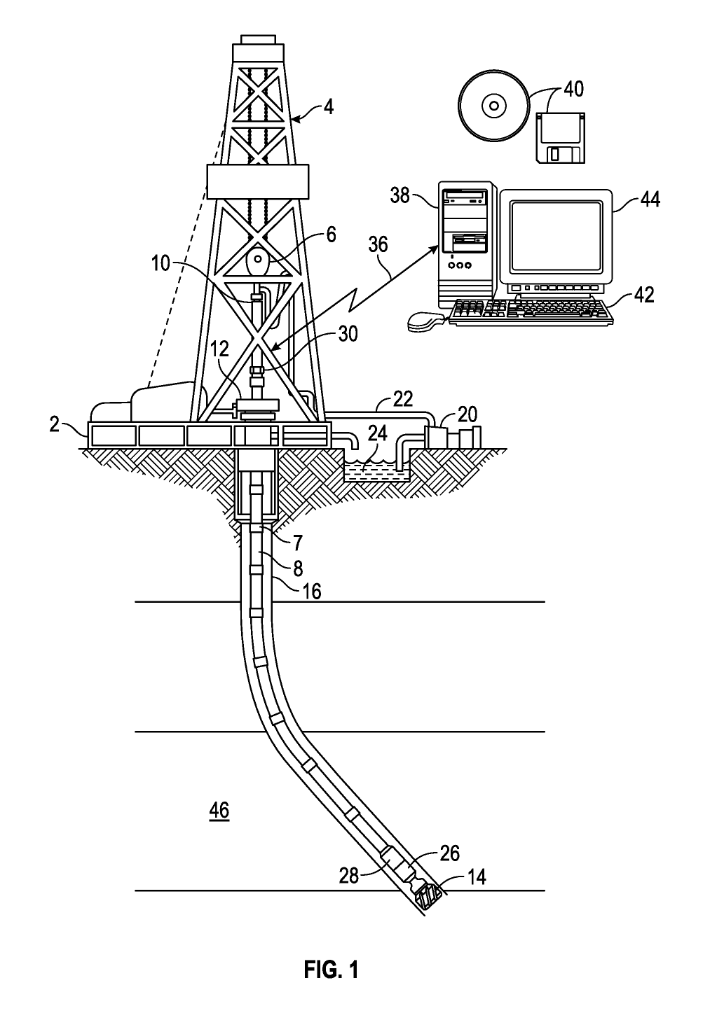

To provide some context for the disclosure, FIG. 1 shows an illustrative well and well components. FIG. 1 includes a drilling platform 2 supporting a derrick 4 having a traveling block 6 for raising and lowering a drill string 8. A rotary table 12 rotates the drill string 8 as it is lowered into the well. A pump 20 circulates drilling fluid through a feed pipe 22, through a kelly 10, downhole through the interior of drill string 8, through orifices in drill bit 14, back to the surface via the annulus around drill string 8, and into a retention pit 24.

The drill bit 14 is just one well component of a bottom-hole assembly that typically includes one or more drill collars 26 (thick-walled steel pipe) to provide weight and rigidity. Some of these drill collars 26 may include additional well components, such as logging instruments to gather measurements of various parameters such as position, rotational or azimuthal orientation, borehole diameter, etc. A telemetry sub 28 may be included and coupled to the drill collar 26 to transfer measurement data to a surface receiver 30 and/or to receive commands from the surface. Various forms of telemetry exist and may include mud pulse telemetry, acoustic telemetry, electromagnetic telemetry, or telemetry via wired pipe segments.

The telemetry signals are supplied via a communications link 36 to a computer 38 or some other form of a data processing device. Computer 38 operates in accordance with software (which may be stored on information storage media 40) and user input via an input device 42 to process and decode the received signals. The resulting telemetry data may be further analyzed and processed by computer 38 to generate a display of useful information on a computer monitor 44 or some other form of a display device. For example, an operator could employ this system to obtain and monitor drilling parameters, formation properties, and the path of the borehole relative to an existing borehole and any detected formation boundaries. A downlink channel can then be used to transmit steering commands from the surface to the bottom-hole assembly.

Data collected from a well being drilled as described above may be combined with historical and survey data for the well and for other wells (e.g., wells within the same reservoir) and provided as input to analysis software for well engineering. One example of such analysis software is Halliburton's DecisionSpace® Well Engineering Software, such analysis software being used to anticipate potential problems and to provide solutions to actual problems encountered during drilling.

The software may be used to define a “case” or “drilling scenario” that describes a wellbore based on known or anticipated data (e.g., geology, lithography, formation resistivity, drill string location and condition within the borehole, etc.) and also describes a specific set of wellbore conditions or problems addressed by the analysis (e.g., a stuck bit, unexpected geology and/or lithography, etc.). Once the scenario is defined, the software may be used to determine a course of action and/or equipment configuration that may be used to resolve the problem described by the scenario (e.g., the configuration of a workstring to extract a stuck bit).

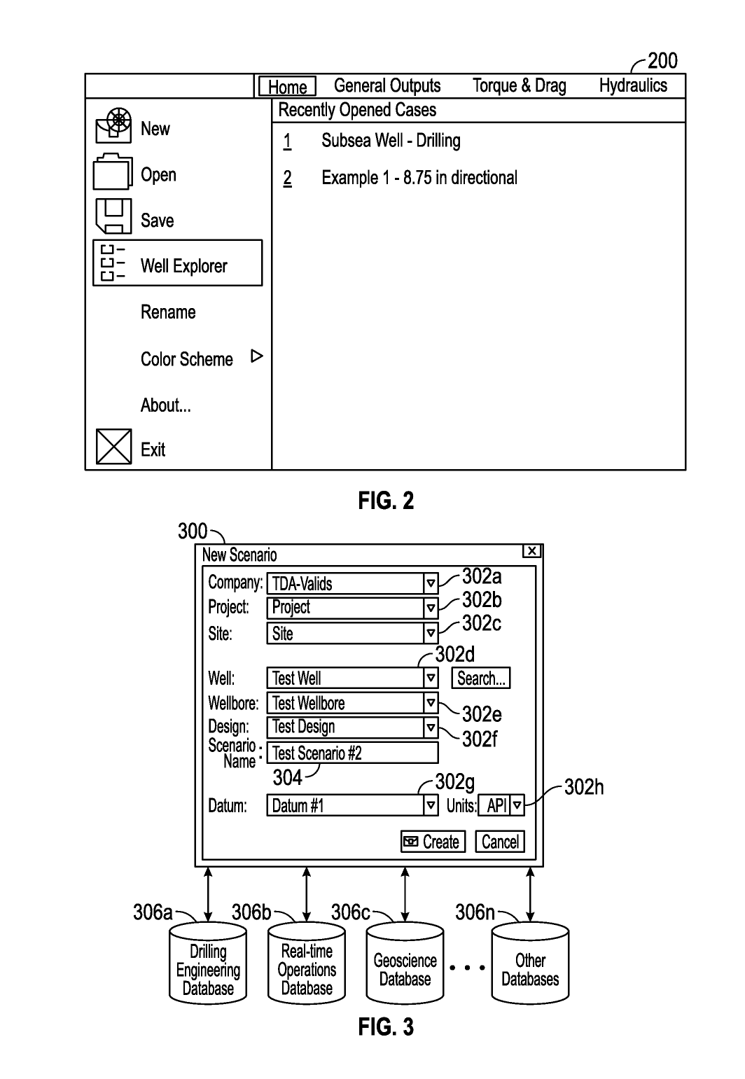

Because of the disparate nature of the various data sources accessed by the well analysis software, in at least some illustrative embodiments the analysis software may display a visual representation of the well including well components similar to those discussed above. FIGS. 2-3 illustrates exemplary user interface screens and prompts to guide the user through the scenario-building process.

FIG. 2 illustrates one embodiment of an initial user interface display 200. The display 200 gives the user options such as creating a new scenario, opening a previously saved scenario, or saving the current scenario. In the process of creating a new scenario, a dialogue box 300 such as depicted in FIG. 3 may be used to obtain information from the user. As depicted, the dialog box 300 includes various user input combo boxes 302a-h allowing the user to choose hierarchical elements such as an existing company 302a, project 302b, site 302c, well 302d, wellbore 302e, design 302f, and datum 302g (e.g., a point of reference for depth that can be used to align various data sets).

The user input combo boxes 302a-h may be hierarchical in the sense that selection of one is required prior to another being populated, and may also dictate what information the latter is populated with. For example, selection of a well 302d may be required prior to selection of the wellbore 302e, and may also dictate which wellbores are populated into the wellbore 302e selection box. Alternative embodiments may additionally enable the user to create new hierarchical elements. The dialog box 300 further allows the user to enter a scenario name 304 which may be used or correlated with the combo boxes 302a-h if the scenario is saved for future use.

The combo boxes 302a-h may be associated with various databases 306a-n. Such databases 306a-n may include, for example and without limitation, a drilling engineering database 306a containing a catalog of specifications for each well component, a real-time operations database 306b containing real-time (or near real-time) drilling information, such as downhole depth, pressures, parameters, true trajectory, and the like, and a geoscience database 306c including formation and other subsurface information. It should be appreciated that each user input box 302a-h is not limited to retrieving data from a single database 306a-n, but is indeed likely to retrieve data from numerous databases as necessary to properly populate with the appropriate selections for the user.

Multiple companies or sources may have simultaneous access and populate the databases 306a-n. For example, a first company may populate the drilling engineering database 306a with details regarding design features and specifications for some well components, whereas a second company may populate the geoscience database 306c with geological information of the earth's formation around the well. Additionally, various companies may populate the same (single) database, for example, multiple companies inputting designs or specifications for their product into the drilling engineering database 306a.

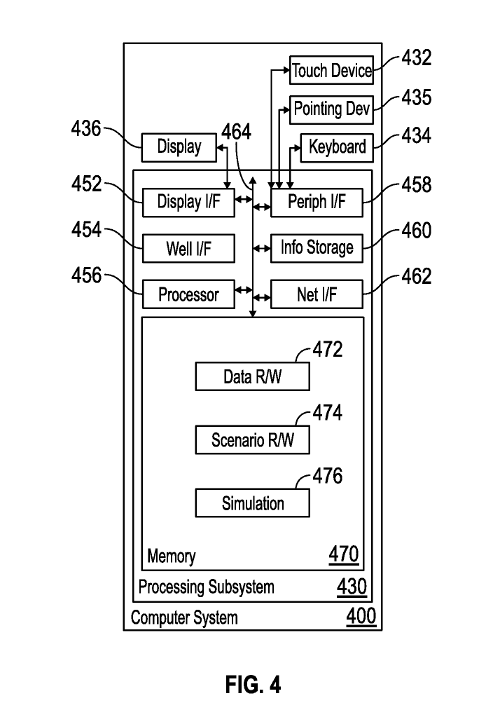

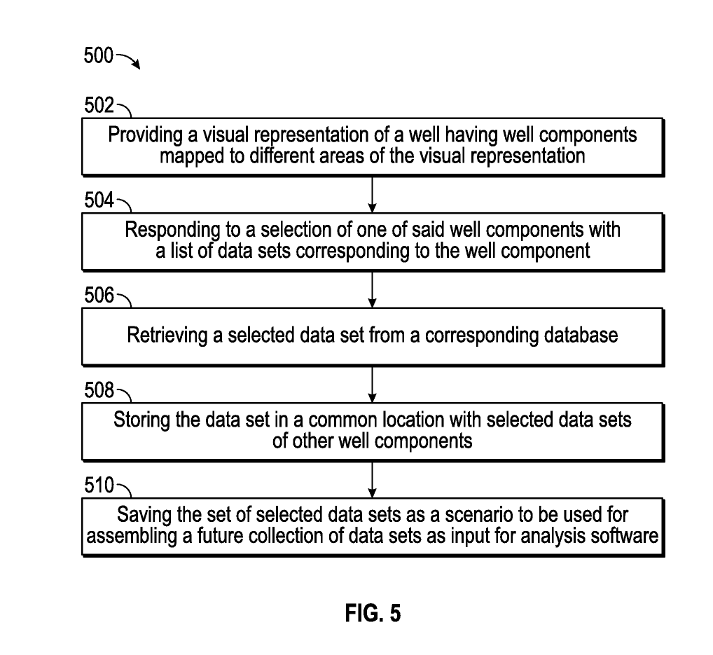

In at least some illustrative embodiments, the above-described well visualization and user interface may be implemented as a computer program stored in a non-transitory computer readable medium within a computer system, such as computer system 400 of FIG. 4, which may be similar to the computer 38 of FIG. 1. Both hardware and software components of computer system 400 are shown, which in at least some illustrative embodiments implement at least part of method 500 in FIG. 5 (described in more detail below). A user may interact with computer system 400 via one or more user input devices 432, 434, 435, such as a touch device 432 (e.g., touch pad or touch screen), a keyboard 434 and/or a pointing device 435 (e.g., a mouse), and a display 436 to configure, control, and view the well simulation and visualization. As depicted, the computer system 400 includes a processing subsystem 430 having a display interface (“I/F”) 452, a well interface 454, a processor 456, a peripheral interface 458, an information storage device 460, a network interface 462, and a memory 470. Bus 464 couples each of these elements to each other and transports their communications therebetween.

The interfaces 452, 454, 458, and 462 may be a combination of hardware and/or software which controls and coordinates interaction between the memory 470 and overall processing subsystem 430, and components connected to the computer 400 (e.g., the display 436 and peripheral devices 432, 434, 435). Moreover, the interfaces 452, 454, 458, and 462 may enable communication with components external to the computer 400, such as external databases (e.g., a central database server housing well logging data) that may interact with the computer 400 via the network interface 462. The memory 470 may include various modules, such as a data Read/Write (“R/W”) module 472, a scenario R/W module 474, and a simulation module 476. The data R/W module 472 may be capable of reading and writing data to/from various sources, including databases and/or the memory of other computers. Similarly, the scenario R/W module 474 may be capable of reading or writing (saving) all data or parameters (e.g., database selections and calls) related to an entire scenario. The simulation module 476 is capable of simulating or predicting well conditions, possibly by running simulation models, based on the user selected data sets for each well component.

In exemplary operation, the processor 456 may provide a visual representation of a well, including well components mapped to different areas, on the display 436. The input devices 432, 434, 435 may be used by the user to select one of the well components, such as the drill bit, whereby the processor 456 receives the user input and responds by displaying a list of corresponding data sets available (e.g., all drill bits available). Upon selection of a data set (e.g., a particular drill bit) from the list, the processor 456 may utilize the data R/W module 472 to retrieve the selected data set from a corresponding database, for example, via a local database in the information storage device 460 or possibly through a remote database via the network interface 462.

Example databases may include, but are not limited to, a central repository, a drilling engineering database, a real-time operations database (i.e., real-time data being acquired from a well), and a geoscience or geological and geophysical database. Such databases servers may be running a variety of operating systems and/or database languages. Therefore, advantageously, the system is programmed to use the appropriate programing language and database query as required for each database.

The processor may additionally update the visual representation on the display 436 via the display interface 452 to reflect the selection, advantageously, making it easier for the user to quickly identify the selection for the well component (and all well components in an overall glance). Upon retrieval of the data set, the data R/W module 472 may again be utilized to store the data set in a common location with data sets of the other well components, for example in the memory 470, information storage device 460, or an external location via the network interface 462.

The processor 456 may employ the simulation module 476 to obtain an analysis result or forecast of the well using part or all of the selected data sets. For example, a user may have selected data sets for a drill bit type and a drilling pipe being used in a particular well to drill through a particular formation. Thus, the simulation module 476 may perform an analysis to predict drilling depth the bit may last before requiring replacement. Based on the analysis, the processor 456 may perform a well-related action, for example, determining the torque or speed to drive the drill bit with, or determining the composition of the drilling mud to be used. Such analysis is not limited to pre-drilling predictions, and may additionally be performed while the well is being drilled. In either case, such analysis and actions taken likely decrease drilling time and increasing efficiency.

Prior to performing the analysis, the processor 456 may correlate two or more of the data sets based on a common field of each data set, for example by aligning timestamp fields of the data sets to assure the data was obtained at the same time. In further examples, the datum field 302g (FIG. 3) may be utilized to align or correlate the downhole depth of data sets.

The data sets are most likely read from various databases, thus the processor 456 may further resolve inconsistent information between the databases. For example, the processor 456 may detect updated data obtained from real-time monitoring, or may simply do an equality check to see if the data in one of the database has changed since last read. If so, the processor 456 may automatically select and use the newest data. Alternatively, the processor 456 may alert the user of such change and prompt the user via the display 436 for a determination of which data set should be used. Upon such determination, the processor 456 may employ the data R/W module 472 to replace the old or incorrect information with the updated or selected data.

In some embodiments, the processor 456 may utilize the scenario R/W module 474 to save the full set of selected data sets in a computer memory (e.g., the memory 470, information storage device 460, or an external location via the network interface 462) as a scenario to be used for constructing a future input data set for the analysis software. For example, the user may desire to run the scenario again once the well is partially drilled to compare real-time or acquired data with prior predictions and determine if changes in the well components or drilling is required. To do such, the processor 456 may prompt the user for a username and password. Upon verification of identity, the processor 456 may again utilize the scenario R/W module 474 to retrieve the full set of previously selected and saved data corresponding to the user's run. Additionally, the processor 456 may filter the data, such as filtering out invalid or irrelevant data (data not required for a particular scenario). The processor 456 may also filter the data by means of down-sampling, thereby maintaining enough data for the analysis, but increasing processing speed and saving memory space by having to process fewer data points.

It will be appreciated by those of skill in the art that a single computer system 400 is depicted as having a single processing system 430 with a single memory 470 merely for illustrative and exemplary purposes. However, each may be connected or implemented across numerous computer systems, processing systems, and/or memories, and include more or fewer components, while being within the scope of the present disclosure.

FIG. 5 is a flow diagram of an illustrative method 500 for compiling a scenario. As mentioned above, the method 500 may be implemented at least in part by a computer system, such as computer system 400. The computer system implements the method 500 beginning at block 502, where the computer system and display provide a visual representation of a well having well components mapped to different areas of the representation. At block 504, the system responds to a user selection of a well component by providing a list of data sets corresponding to the well component. For example, the user may select the drill bit as the well component, whereby the system provides the user with a list of drill bits.

The system then receives the user's selection of a particular data set (e.g., a particular drill bit) and actually retrieves data associated with that data set from a corresponding database, as at block 506. Example databases may include, but are not limited to, a central repository, a drilling engineering database, a real-time operations database (i.e., real-time data being acquired from a well), and a geoscience or geological and geophysical database. Such databases servers may be running a variety of operating systems and/or database languages. Therefore, advantageously, the system is programmed to use the appropriate programing language and database query as required for each database.

The system may additionally update the visual representation to reflect the data set selection, advantageously, making it easier for the user to quickly identify the selection for the well component (and all well components) in an overall glance. For example, such updates may take the form of a text label and/or color scheme specifying the selected data set for each well component.

Upon retrieval of a data set, the system may store the data set in a common location with data sets of the other well components, as at block 508. At block 510, the system may save the full set of selected data sets in a computer memory as a scenario to be used for constructing a future input data set for said analysis software. For example, the user may initially run the scenario prior to a well being drilled, but then desire to run the scenario again at a later point in time once the well is partially drilled to compare real-time data with prior predictions and determine if changes in the well components or drilling is required.

Prior to, or during analysis of the scenario, the system of method 500 may correlate two or more of the data sets based on a common field of each data set, for example, by aligning timestamp fields of the data sets to assure the data was obtained at the same time. In further examples, downhole depth fields may be used to align or correlate the data sets. As the data sets may be stored in various databases, the system may further resolve inconsistent information between various databases. For example, the system may detect updated data obtained from real-time monitoring, or may simply do an equality check to see if the data in one of the database has changed since last read. If so, the system may automatically select the newest data. Alternatively, the system may alert the user of such change and prompt the user for a determination of which data should be used. Upon such determination, the old or incorrect information may be replaced with the updated or selected data.

After various component selections have been made, the system may perform a scenario analysis using part or all of the data sets. For example, the analysis may predict drilling depth a bit may last before requiring replacement. In addition thereto, the system may perform a well-related action based on the analysis result, for example, deciding the torque or speed to drive the drill bit with, or the composition of the drilling mud to be used. Such action may be decided either automatically by the system or by manual user input. In general, such analysis is not limited to pre-drilling predictions, and may additionally be performed while the well is being drilled.

The system may be capable of saving and retrieving scenarios. Upon retrieval, the system may prompt the user for a username and password. Upon verification of identity, the system may retrieve previously selected and saved data. Moreover, the method 500 may filter the data, wherein the system filters out invalid or irrelevant data (data not required for a particular scenario). The system may also filter the data by means of down-sampling, thereby maintaining enough data for the analysis, but increasing processing speed and saving memory space by having to process fewer data points.

Embodiments disclosed herein include:

A: A scenario compiling method that includes providing a visual representation of a well having well components mapped to different areas of the visual representation, responding to a selection of one of the well components with a list of data sets corresponding to the well component, retrieving a selected data set from a corresponding database, storing the data set in a common location with selected data sets of other well components, and saving the selected data sets as a scenario to be used for assembling a future collection of data sets as input for analysis software.

B: A nontransient information storage medium having a scenario compiling program that causes a processor to implement a method including providing a visual representation of a well having well components mapped to different areas of the visual representation, responding to a selection of one of the well components with a list of data sets corresponding to the well component, retrieving a selected data set from a corresponding database, storing the data set in a common location with selected data sets of other well components, and saving a set of data set selections as a scenario to be used for assembling a future collection of data sets as input for analysis software.

Each of embodiments A and B may have one or more of the following additional elements in any combination: Element 1: updating the visual representation based on a selection of one of the data sets. Element 2: applying the analysis software to the stored data to obtain an analysis result, and performing a well-related action based on the analysis result. Element 3: correlating data of at least two of the data sets based on at least one common field in each data set. Element 4: resolving inconsistent information between at least two of the databases to obtain a consistent data set, and replacing the data set in at least one of the databases with the consistent data set. Element 5: where the resolving is performed by a user selecting the data set of one database to be the consistent data. Element 6: where at least one of the databases includes real-time data from a well. Element 7: where the databases includes at least one of the group including a central repository, drilling engineering database, real-time database, and geoscience database. Element 8: where performing the well-related action is performed during the drilling process of a well. Element 9: filtering the data set based on a user input including at least one of the group of a project, a site, a well, a wellbore, a wellbore design. Element 11: further comprising retrieving the full set of selected data.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A scenario compiling method that comprises:
providing a visual representation of a well having well components mapped to different areas of the visual representation;
responding to a selection of one of said well components with a list of data sets corresponding to the well component;
retrieving a selected data set from a corresponding database;
storing the data set in a common location with selected data sets of other well components; and
saving the selected data sets as a scenario to be used for assembling a future collection of data sets as input for analysis software.

2. The method of claim 1, further comprising updating the visual representation based on a selection of one of said data sets.

3. The method of claim 1, further comprising:
applying said analysis software to the stored data to obtain an analysis result; and
performing a well-related action based on the analysis result.

4. The method of claim 1, further comprising correlating data of at least two of the selected data sets based on at least one common field in each data set.

5. The method of claim 1, further comprising:
resolving inconsistent information between at least two of the databases to obtain a consistent data set; and
replacing the data set in at least one of the databases with the consistent data set.

6. The method of claim 5, wherein said resolving is performed by a user selecting the data set of one database to be the consistent data.

7. The method of claim 1, wherein at least one of the databases includes real-time data from a well.

8. The method of claim 1, wherein the databases includes at least one of the group including a central repository, drilling engineering database, real-time database, and geoscience database.

9. The method of claim 3, wherein performing the well-related action is performed during the drilling process of a well.

10. The method of claim 1, further comprising filtering the list of data sets based on a user input including at least one of the group of a project, a site, a well, a wellbore, a wellbore design.

11. A nontransient information storage medium having a scenario compiling program that causes a processor to implement a method comprising:
providing a visual representation of a well having well components mapped to different areas of the visual representation;
responding to a selection of one of said well components with a list of data sets corresponding to the well component;
retrieving a selected data set from a corresponding database;
storing the data set in a common location with selected data sets of other well components; and
saving a set of data set selections as a scenario to be used for assembling a future collection of data sets as input for analysis software.

12. The medium of claim 11, further comprising updating the visual representation based on a selection of one of said data sets.

13. The medium of claim 11, further comprising:
applying said analysis software to the stored data to obtain an analysis result; and
performing a well-related action based on the analysis result.

14. The medium of claim 11, further comprising correlating data of at least two of the selected data sets based on at least one common field in each data set.

15. The medium of claim 11, further comprising:
resolving inconsistent information between at least two of the databases to obtain a consistent data set; and
replacing the data set in at least one of the databases with the consistent data set.

16. The medium of claim 15, wherein said resolving is performed by a user selecting the data set of one database to be the consistent data.

17. The medium of claim 11, wherein at least one of the databases includes real-time data from a well.

18. The medium of claim 11, wherein the databases includes at least one of the group including a central repository, drilling engineering database, real-time database, and geoscience database.

19. The medium of claim 13, wherein performing the well-related action is performed during the drilling process of a well.

20. The medium of claim 11, further comprising filtering the list of data sets based on a user input including at least one of the group of a project, a site, a well, a wellbore, a wellbore design.
